(19) United States
(12) Patent Application Publication
(10) Pub. No.: US 2005/0274181 A1
(43) Pub. Date: Dec. 15, 2005

(54) Vibration type angular rate sensor

(75) Inventors: Yuji Kutsuna, Oobu-shi (JP); Hajime Ito, Ichinomiya-shi (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 11/149,431

(22) Filed: Jun. 10, 2005

(30) Foreign Application Priority Data
Jun. 11, 2004 (JP) 2004-174688

(51) Int. Cl. G01P 15/08

(52) U.S. Cl. 73/504.12

(57) ABSTRACT

An angular rate sensor has a vibrator vibrating along a reference direction at a fixed frequency in response to a driving signal, and vibrating along a detecting direction perpendicular to the reference direction in accordance with an angular velocity given to the vibrator. A monitoring signal generator generates a monitoring signal having a waveform of the vibrator vibration along the reference direction. A clock signal generator generates, from the monitoring signal, a first clock signal and a second clock signal having a frequency identical with that of the first clock signal and a level change occurring at a time differing from that in the second clock signal. The first clock signal is used to maintain the vibrator vibration along the reference direction. An angular velocity detector detects the angular velocity from a waveform of the vibrator vibration along the detecting direction by using the second clock signal.

### CROSS-REFERENCE TO RELATED APPLICATION

This application is based upon and claims the benefit of priority of the prior Japanese Patent Application 2004-174688 filed on Jun. 11, 2004 so that the contents of which are incorporated herein by reference.

### BACKGROUND OF THE INVENTION

1. Field of the Invention

The present invention generally relates to a vibration type angular rate sensor in which a vibrator vibrates in response to a driving signal, and an angular velocity given to the vibrator is detected as an angular rate while raising a level of the driving signal and applying a bias voltage to a movable portion of the vibration.

2. Description of Related Art

As an angular rate sensor (or gyro sensor), a mechanical type sensor, an optical type sensor and a flowing fluid type sensor are well known. In the mechanical type, precession of a rotated body is used to detect an angular velocity given to the body as an angular rate. In the optical type, reception timing of a beam of a laser circulated in a rotated box is changed in response to an angular velocity given to the box, and the angular velocity is detected based on a degree of the change. In the flowing fluid type, gas is injected to a heated wire in a rotated box. An amount of injected gas is changed in response to an angular velocity given to the box, and temperature of the heated wire depends on the amount of injected gas. The angular velocity is detected based on the temperature of the heated wire.

Further, an angular rate sensor has been recently in great demand which is used for a vehicle control system, a car navigation system or the like. Particularly, a vibration type angular rate sensor is cheep and light in weight as compared with the other types, so that this vibration type has been mainly used for vehicle. For example, Published Japanese Patent First Publication No. 2003-021517 proposes an angular velocity measuring device for vehicle wherein the existence of a failure of the device is quickly detected.

In this vibration type, a vibrator vibrates in a predetermined reference direction at a fixed frequency in response to a driving signal generated from a vibration component of the vibrator along the reference direction. When an angular velocity is given to the vibrator, Corioli's force is generated along a detecting direction perpendicular to the reference direction, and the Corioli's force additionally vibrates the vibrator along the detecting direction. A second vibration component of the vibrator along the detecting direction is detected from the vibrator, and information of the angular velocity is obtained from this second vibration component.

More particularly, asynchronous detection unit is used in the vibration type angular rate sensor to detect an angular velocity signal indicating the angular velocity from the second vibration component of the vibrator. The strength of the Corioli's force is proportional to a vector product of a vibration velocity of the vibrator along the reference direction and an angular velocity given to the vibrator, and a signal indicating the vibration velocity of the vibrator is controlled to have a sine waveform according to the driving signal which has a vibration waveform of a fixed frequency. As a result of this control, the angular velocity signal based on the Corioli's force has the same frequency as that of the driving signal. Therefore, a wave detecting clock signal having the same frequency as that of the driving signal is generated from a sine wave signal having the same waveform as that of the driving signal, and a synchronous phase detector detects the angular velocity signal from the second vibration component of the vibrator on the basis of the synchronous detection using the wave detecting clock signal.

Further, when the driving signal is set at a predetermined voltage level generally used in a control system, the voltage applied to the vibrator is insufficient to reliably vibrate the vibrator. Therefore, a voltage boosting circuit is provided to boost a voltage level of the driving signal and to apply a boosted voltage to a movable portion of the vibrator as a bias voltage. In this case, the voltage boosting circuit requires a voltage boosting clock signal to boost a voltage generally applied to the control system. When a circuit for generating the voltage boosting clock signal is provided in addition to a control circuit of the sensor, the size of the sensor is extremely enlarged.

To reduce the sensor size, the voltage boosting clock signal is generated from a sine wave signal having the same waveform as that of the driving signal in the same manner as the wave detecting clock signal. In this case, each of the clock signals changes its level when the corresponding sine wave signal goes across its zero level. Therefore, the voltage boosting clock signal has the same frequency and phase as those of the wave detecting clock signal, and the level of the voltage boosting clock signal is changed almost simultaneously with a time at which the sine wave signal used for generating the wave detecting clock signal goes across its zero level.

However, noises generated due to a level change of the voltage boosting clock signal are easily superposed on the sine wave signal used for generating the wave detecting clock signal In this case, the noises of the voltage boosting clock signal are placed near the zero level of the sine wave signal corresponding to level changing edges of the wave detecting clock signal. As a result, the wave detecting clock signal is easily subjected to chattering or the like caused by the noises, and the precision of the wave detection for detecting the angular velocity signal is undesirably lowered.

### SUMMARY OF THE INVENTION

An object of the present invention is to provide, with due consideration to the drawbacks of the conventional vibration type sensor, a vibration type angular rate sensor wherein an angular velocity given to a vibrator is detected with a high precision by using a wave detecting clock signal obtained from a waveform of vibration of the vibrator while a voltage boosting clock signal obtained from the vibration waveform is used to maintain the vibration of the vibrator.

In an aspect of this invention, a vibration type angular rate sensor is provided which comprises a vibrator, a monitoring signal generator, a clock signal generator and an angular velocity detector. The vibrator vibrates along a reference direction at a fixed frequency in response to a driving signal, receives an angular velocity given to the vibrator, and vibrates along a detecting direction perpendicular to the reference direction in accordance with the angular velocity. The monitoring signal generator generates a monitoring signal having a waveform of the vibration of the vibrator along the reference direction. The clock signal generator generates, from the monitoring signal, a first clock signal and a second clock signal having a frequency identical with that of the first clock signal in a manner that a level of the first clock signal is changed at a time differing from that in the second clock signal. The first clock signal is used to maintain the vibration of the vibrator along the reference direction. The angular velocity detector detects the angular velocity from a waveform of the vibration of the vibrator along the detecting direction by using the second clock signal and outputs the detected angular velocity as an angular rate given to the vibrator.

Therefore, because a level of the first clock signal is changed at a time differing from that in the second clock signal, the second clock signal is hardly deformed by noises generated during the generation of the first clock signal. Accordingly, synchronous detection can be performed for a signal indicating the vibration of the vibrator along the detecting direction by using the second clock signal while the first clock signal is used to maintain the vibration of the vibrator, and the angular velocity can be detected with a high precision.

### BRIEF DESCRIPTION OF THE DRAWINGS

FIG. 1 is a view showing the configuration of a vibration type angular rate sensor according to an embodiment of the present invention;

FIG. 2 is a plan view showing an exemplary structure of a vibrator shown in FIG. 1;

FIG. 3 is a view showing a voltage boosting circuit shown in FIG. 1;

FIG. 4 shows a relationship in phase between a voltage boosting clock signal and a wave detecting clock signal;

FIG. 5A shows a sine wave signal wa and a square wave signal wb obtained from the sine wave signal wa when no noises are superposed on the signal wa;

FIG. 5B shows a deformed sine wave signal wa′ and a deformed square wave signal wb′ obtained from the deformed sine wave signal wa′ in a case where noises are superposed on the signal was when the sine wave signal wa′ is placed at a level near to its zero level; and

FIG. 5C shows the phase shifted vibration monitoring signal wa and the wave detecting clock signal wb obtained when noises generated by the voltage boosting clock signal are superposed on the signal wa according to this embodiment.

### DETAILED DESCRIPTION OF THE PREFERRED EMBODIMENTS

An embodiment of the present invention is described with reference to the accompanying drawings,

### Embodiment

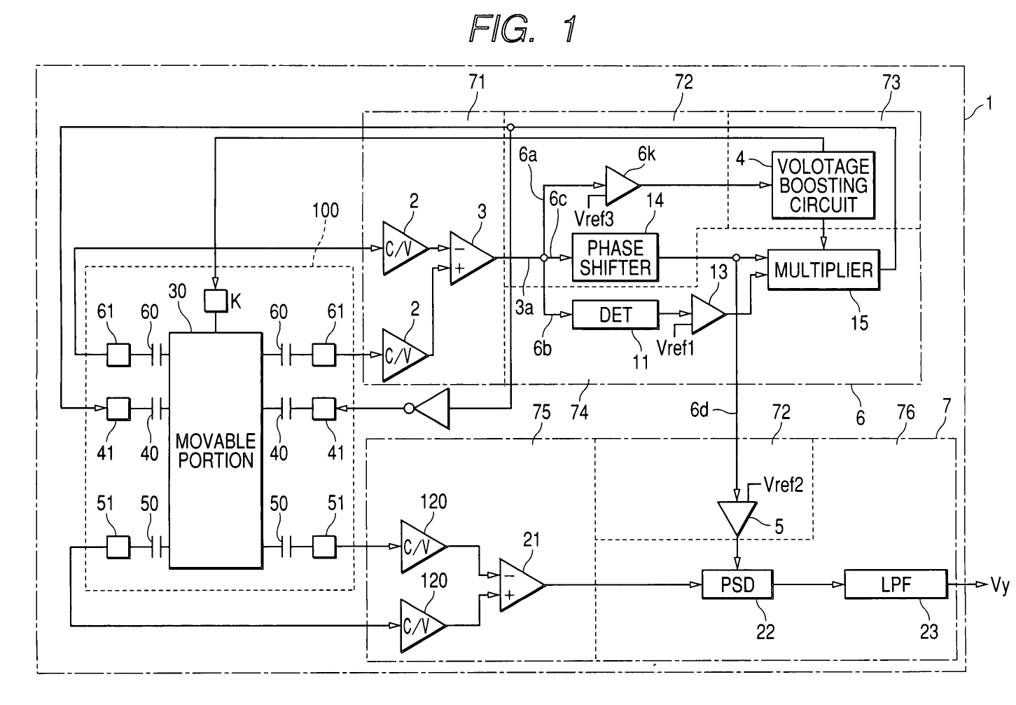

FIG. 1 is a view showing the configuration of a vibration type angular rate sensor according to an embodiment of the present invention. As shown in FIG. 1, an angular rate sensor 1 has a vibrator 100, a monitoring signal generating unit 71, a clock signal generating unit 72 and an angular velocity detecting section 7.

The vibrator 100 vibrates along a predetermined reference direction at a fixed frequency in response to a driving signal, receives an angular velocity given to the vibrator 100, and vibrates along a detecting direction perpendicular to the reference direction in accordance with the angular velocity. The generating unit 71 generates a monitoring signal which has a waveform indicating the vibration of the vibrator along the reference direction. The generating unit 72 generates, from the monitoring signal, a first clock signal and a second clock signal having a frequency identical with that of the first clock signal in a manner that a level of the first clock signal is changed at a time differing from that in the second clock signal. The first clock signal is used to maintain the vibration of the vibrator along the reference direction. The detecting section 7 detects the angular velocity from a waveform indicating the vibration of the vibrator along the detecting direction by using the second clock signal and outputs the detected angular velocity as an angular rate given to the vibrator.

Preferably, the angular rate sensor 1 have a driving signal generating unit 74 to generate the driving signal from the monitoring signal and transmits the driving signal to the vibrator 100 to vibrate the vibrator 100 along the reference direction at the fixed frequency. Further, the angular rate sensor 1 preferably have a voltage boosting unit 73 to boost an applied voltage Vcc by using the first clock signal and to generate a boosted voltage. The boosted voltage is used to stably vibrate the vibrator 100.

A vibration driving section 6 is composed of the generating units 71, 72 and 74 and the boosting unit 73.

The angular velocity detecting section 7 has a second vibration detecting unit 75 and an angular velocity detecting unit 76. The detecting unit 75 detects a vibration component along the detecting direction from the vibration of the vibrator 100, and generates a vibration detecting signal having a modulated waveform of the angular velocity from the detected vibration component along the detecting direction. The detecting unit 76 detects the angular velocity along the detecting direction from the vibration detecting signal by using the second clock signal.

The configuration of the angular rate sensor 1 is described in more detail.

The vibrator 100 is, for example, made of a semiconductor substrate such as a silico non insulator (SOI) substrate by using a well-known semiconductor manufacturing technique. The SOX substrate has a thinned silicon layer, an oxide film and a bane wafer (or another silicon layer) attached to the thinned silicon layer through the oxide film.

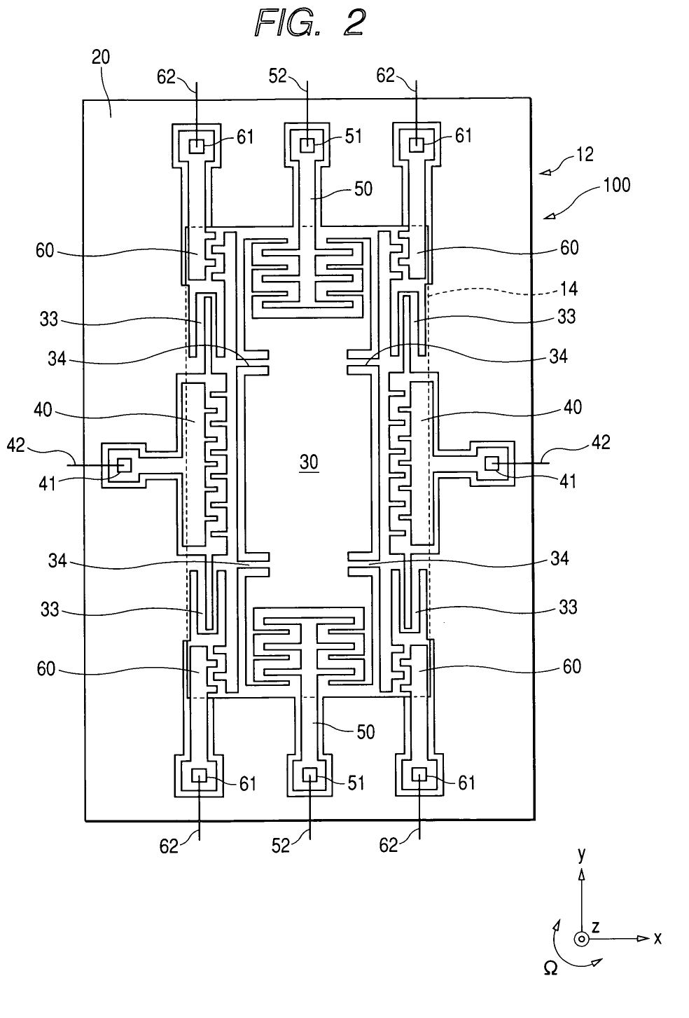

FIG. 2 is a plan view showing an exemplary structure of the vibrator 100. In FIG. 2, an opening 14 is provided in an 901 substrate by partially removing both an oxide film (not shown) supporting a thinned silicon layer 12 and another silicon layer (not shown) attached to the layer 12 through the oxide film. Grooves are provided in the silicon layer 12 to divide the silicon layer 12 into a movable portion 30 disposed in the opening 14 and a base portion 20 surrounding the movable portion 30. The movable portion 30 has driving beams 33 and detecting beams 34 through which the movable portion 30 is supported by the base portion 20. Each driving beam 33 is deformable as a spring along a reference direction X. Each detecting beam 34 is deformable as a spring along a detecting direction Y perpendicular to the reference direction X on the surface of the silicon layer 12.

Driving electrodes 40, detecting electrodes 50 and monitoring electrodes 60 are disposed at positions at which the periphery of the movable portion 30 faces the base portion 20. Each electrode has tooth portions formed in a comb-teeth shape. A driving signal having a sine waveform at a fixed frequency is applied to the movable portion 30 through the driving electrodes 40. A vibration component of vibration of the movable portion 30 along the reference direction X is outputted as a vibration monitoring signal to the vibration detecting unit 71 through the monitoring electrodes 60.

The angular rate sensor 1 is, for example, mounted on a vehicle so as to make a plane defined by the directions X and Y being in parallel to a horizontal plane.

When a rotational force is applied to the vibrator 100 by changing a running direction of the vehicle, an angular velocity (or angular rate) Ω denoting time integration of the rotational force is generated and given to the vibrator 100 along a rotational direction (or vertical direction) around the z axis perpendicular to a plane defined by the directions X and Y. In this case, the vibrator 100 additionally vibrates along the detecting direction Y, and a capacitance of a capacitor surrounded by the detecting electrodes 50 is changed. The change of the capacitance is outputted through the detecting electrodes 50 as a detecting signal of the angular velocity Ω along the detecting direction Y.

The SOI substrate having the vibrator 100 is mounted on a circuit substrate (not shown). The electrodes 40, 50 and 60 are electrically connected to the circuit substrate through terminals 41, 51 and 61 and wires 42, 52 and 62, respectively.

When a driving signal having a sine waveform or the like is inputted from the vibration driving section 6 of the circuit substrate to the driving electrodes 40 and a bias DC voltage is applied to the movable portion 30 through a terminal K (see FIG. 1) of the vibrator 100, the movable portion 30 connected with the base portion 20 through the driving beams 33 vibrates in the direction X. In this driving vibration, frequency and amplitude of the driving vibration of the movable portion 30 are monitored by detecting a change of a capacitance of a capacitor formed by comb teeth of each monitoring electrode 60, and the driving signal is adjusted to maintain the amplitude of the driving vibration at a predetermined value.

When an angular velocity Ω is given to the vibrator 100 during the driving vibration of the movable portion 30, Corioli's force is generated in the movable portion 30 along the direction Y so as to vibrate the detecting beams 34, and the movable portion 30 vibrates along the direction Y. In this detecting vibration, a capacitance of a capacitor formed by comb teeth of each detecting electrode 50 is changed. When this change is outputted as a detecting signal from the detecting electrodes 50 to the angular velocity detecting section 7, strength of the angular velocity Ω is obtained.

Returning to FIG. 1, the detecting unit 71 of the driving section 6 has C/V converters 2 and a differential amplifier 3. The generating unit 72 has a phase shifter 14, a comparator 6k and a comparator 5. The comparator 5 is disposed in the detecting section 7. The boosting unit 73 has a voltage boosting circuit 4. The generating unit 74 has an AC/DC converter 11, a differential amplifier 13 and a multiplier 15.

In operation, a capacitance of a capacitor in each monitoring electrode 60 is changed due to vibration of the movable portion 30 along the direction X. The C/V converters 2 receive signals indicating capacitance changes inverse to each other from the monitoring terminals 61, respectively. Each C/V converter 2 converts the received signal into a voltage signal. The amplifier 3 amplifies a difference between the voltage signals to obtain a vibration monitoring signal having a sine waveform and a fixed frequency. The units 72, 73 and 74 generate a driving signal from the vibration monitoring signal, and transmits the driving signal to the driving terminals 41 of the vibrator 100 to vibrate the vibrator 100 along the direction x at the fixed frequency. Therefore, the driving section 6 is configured as a self-vibration type.

More particularly, the amplifier 3 outputs the vibration monitoring signal to an input line 3a, and the comparator 6k, the AC/DC converter 11 and the phase shifter 14 receive the signal through lines 6a, 6b and 6c branching from the line 3a, respectively. The phase shifter 14 shifts a phase of the vibration monitoring signal by 90 degrees. The AC/DC converter 11 converts an alternating current of the vibration monitoring signal into a direct current to smooth the signal and outputs the smoothed signal as an amplitude detection signal indicating an amplitude of the vibration monitoring signal. The differential amplifier 13 calculates a difference between the level of the amplitude detection signal and a reference voltage Vref1 corresponding to a controlled amplitude level. The difference indicates a degree of correction of the level of the vibration monitoring signal. The differential amplifier 13 outputs an amplitude correction signal indicating the degree of correction to the multiplier 15. The multiplier 15 multiplies a phase shifted vibration monitoring signal outputted from the phase shifter 14 by the correction degree indicated by the amplitude correction signal, and obtains a driving signal set at an adjusted amplitude. Therefore, when the driving signal is inputted to the driving terminals 41 of the vibrator 100, the vibration of the vibrator 100 along the reference direction X is maintained to a predetermined strength. Further, the multiplier 15 boosts a voltage level of the driving signal by using a boosted voltage Vout of the voltage boosting circuit 4.

In short, the phase shifter 14 generates a phase shifted vibration monitoring signal from the vibration monitoring signal, the driving signal obtained from the phase shifted vibration monitoring signal is fed back to the driving electrodes 40 of the vibrator 100 to drive the vibrator 100 vibrating in a vibration waveform along the direction X. Therefore, mechanical vibration of the movable portion 30 can be continued at a frequency near a resonance frequency of the movable potion 30.

Next, the reason that the voltage level of the driving signal is boosted is described.

The vibration monitoring signal detected from the vibrator 100 is amplified to a signal level (maximum differential level between a highest level and a lowest level) of 5V in the amplifier 3. A voltage level of the driving signal generated from the vibration monitoring signal is not sufficient to drive the vibrator 100. Therefore, the voltage level of the driving signal is boosted to a sufficient voltage level of 16 v (maximum differential level) in the multiplier 15 by using a boosted voltage Vout of the voltage boosting circuit 4.

More particularly, a reference voltage Vref3 inputted to the comparator 6k determines the zero level of a sine waveform of a signal inputted to the comparator 6k. In this case, when the comparator 6k receives the vibration monitoring signal of a sine waveform, the comparator 6k changes the signal level higher than the reference voltage Vref3 to a high level and changes the signal level lower than the reference voltage Vref3 to a low level. As a result, the comparator 6k generates a voltage boosting clock signal (or first clock signal) from the vibration monitoring signal. The voltage boosting clock signal has a square waveform of a duty ratio set at 50%. The voltage boosting circuit 4 boosts an applied voltage Vcc by using the voltage boosting clock signal to generate a boosted voltage Vout.

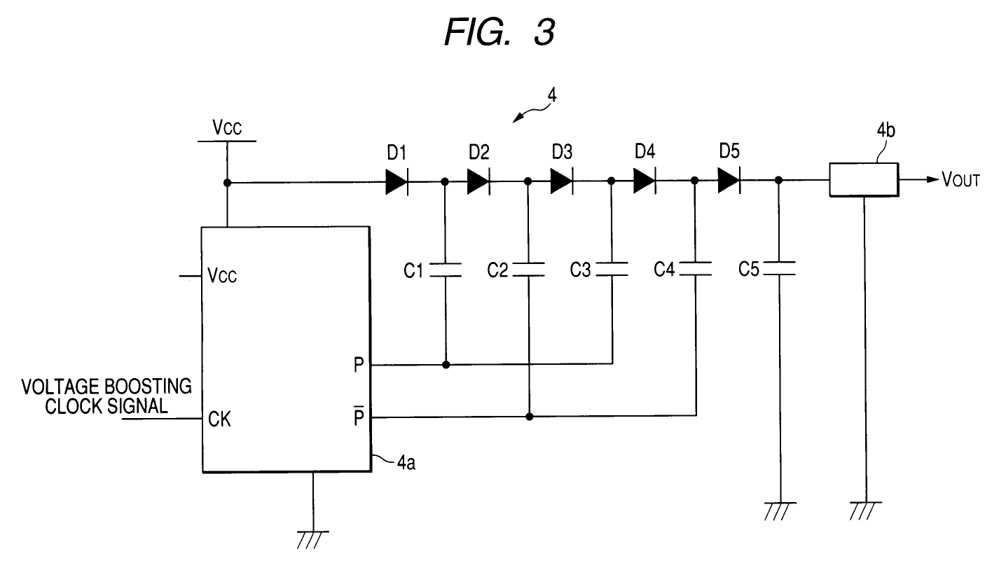

FIG. 3 is a view showing the voltage boosting circuit 4. The voltage boosting circuit 4 configured by a charge pump type circuit has a voltage boosting control circuit 4a receiving the voltage boosting clock signal and an applied voltage Vcc, a series of diodes D1 to D5 receiving the applied voltage Vcc, voltage boosting condensers C1 to CB, and a regulator 4b. The condensers C1 and C3 connect a voltage boosting switching terminal P of the control circuit 4a and output terminals of the diodes D1 and D3, respectively. The condensers C2 and C4 connect an inverted voltage boosting switching terminal P(−) of the control circuit 4a and output terminals of the diodes D2 and D4, respectively. A first voltage booster having the condenser C1 and the diode D1, a second voltage booster having the condenser C2 and the diode D2, a third voltage booster having the condenser C3 and the diode D3 and a fourth voltage booster having the condenser C4 and the diode D4 are obtained.

In operation, the voltage boosting clock signal is inputted to a clock terminal CK of the control circuit 4a, and the applied voltage vcc is inputted to a source power terminal Vcc. During a first level of the clock signal, the applied voltage Vcc is applied to the condensers C1 and C3 through the switching terminal P. During a second level of the clock signal, the applied voltage Vcc is applied to the condensers C2 and C4 through the inverted switching terminal P(−). Therefore, the applied voltage Vcc applied to an input terminal of the diode D1 is boosted in each of the voltage boosters, and an output voltage set four times higher than the applied voltage Vcc is outputted from an output terminal of the diode D4. Then, ripple generated in the output voltage is removed in the combination of the diode DS and the condenser CS, and the output voltage is stabilized in the regulator 4b. A boosted voltage Vout set at 16 v and lower than the output voltage is outputted from the regulator 4b.

The voltage boosting circuit 4 is not limited to a charge pump type. For example, the circuit 4 may be configured by a step up type DC-DC converter circuit using a voltage boosting coil.

In the angular velocity detecting section 7, the detecting unit 75 has capacitance-to-voltage (C/V) converters 120 connected to the detecting electrodes 50, and a differential amplifier 21. The detecting unit 76 has a phase sensitive demodulator (PSD) 22 and a low pass filter (LPF) 23. The c/v converters 120 receive signals indicating capacitance changes inverse to each other from the detecting electrodes 50, respectively. Each C/V converter 120 converts the received signal into a voltage signal indicating a voltage change. The differential amplifier 21 amplifies a difference between the voltage changes to generate a vibration detecting signal indicating an amplitude-modulated angular velocity. The amplifier 21 outputs the vibration detecting signal to the PSD 22.

The comparator 5 of the generating unit 72 receives the phase shifted vibration monitoring signal outputted from the phase shifter 14 through a line 6d and changes the received monitoring signal to a wave detecting clock signal (or second clock signal). More particularly, a reference voltage Vref2 inputted to the comparator 5 determines the zero level of the monitoring signal having a sine waveform received in the comparator 5. Then, the comparator 5 changes the signal level higher than the reference voltage Vref2 (or zero level) to a high level, and changes the signal level lower than the reference voltage Vref2 to a low level. As a result, the comparator 5 generates a wave detecting clock signal from the vibration monitoring signal. The wave detecting clock signal has a square waveform of a duty ratio set at 50% and a reference frequency identical with the frequency of the vibration monitoring signal. The wave detecting clock signal is transmitted to the PSD 22.

The PSD 22 performs the synchronous detection for the vibration detecting signal by using the wave detecting clock signal to demodulate the vibration detecting signal, and generates an angular velocity signal indicating an angular velocity component of the vibration of the vibrator 100 along the detecting direction Y. The angular velocity component is placed within a predetermined frequency zone. The LPF 23 smoothes the angular velocity component of the angular velocity signal and outputs a voltage signal Vy indicating a direct current voltage proportional to the angular velocity (or angular rate). When the angular rate sensor 1 is, for example, mounted on a vehicle, a change of a running direction of the vehicle is calculated from time integration of the angular velocity.

In this embodiment, the comparator 5 generates the wave detecting clock signal of the reference frequency from the phase shifted vibration monitoring signal. Because the strength of Corioli's force induced by the addition of an angular velocity to the vibrator 100 is proportional to a vector product of a vibration velocity of the vibrator vibrating in the reference direction X and the given angular velocity, a waveform of a signal indicating the Corioli's force is necessarily shifted by 90 degrees from that of the vibration monitoring signal. Therefore, the phase of a waveform of the phase shifted vibration monitoring signal shifted by 90 degrees in the phase shifter 14 is identical with that of the signal indicating the Corioli's force (that is, waveform of the angular velocity signal), so that the wave detecting clock signal is useful for the synchronous detection to detect the angular velocity from the vibration detecting signal.

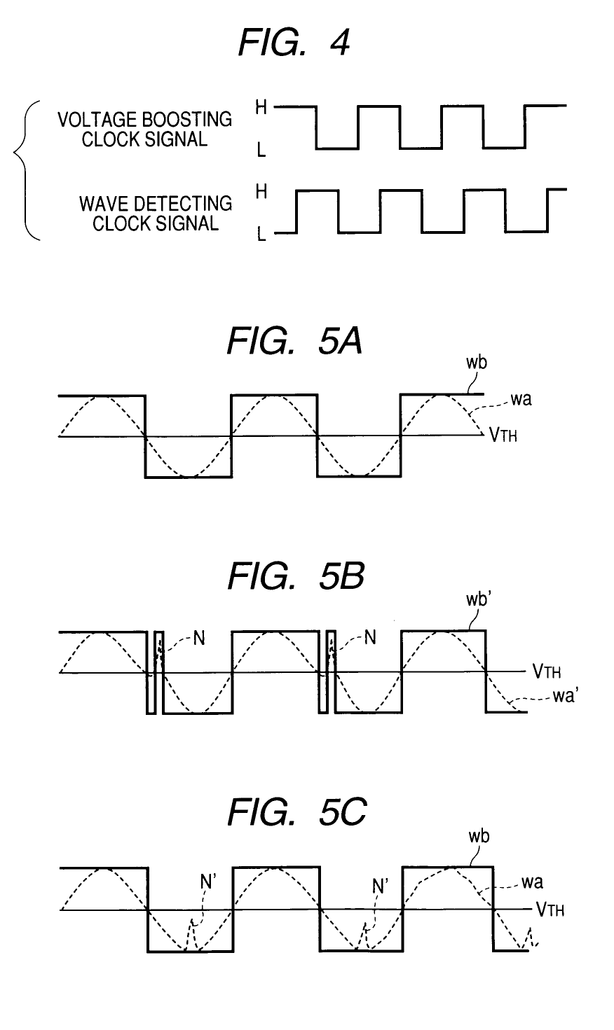

Next, a mechanism for preventing the voltage boosting clock signal from interfering with the generation of the wave detecting clock signal is described with reference to FIG. 4 and FIGS. 5A and 5B. FIG. 4 shows a relationship in phase between the voltage boosting clock signal and the wave detecting clock signal. FIG. 5A shows a sine wave signal wa and a square wave signal wb obtained from the sine wave signal wa, FIG. 5D shows a deformed sine wave signal wa′ and a deformed square wave signal wb′ obtained from the deformed sine wave signal wa in a case where noises are superposed on a sine wave signal when the sine wave signal is placed at a level near to its zero level, and FIG. 5C shows the phase shifted vibration monitoring signal wa and the wave detecting clock signal wb according to this embodiment.

The voltage boosting clock signal is obtained by changing a sine waveform of the vibration monitoring signal to a square waveform, and the wave detecting clock signal is obtained by changing a sine waveform of the phase shifted vibration monitoring signal to a square waveform.

Therefore, as shown in FIG. 4, the clock signals have the same frequency and square waveforms of which the phases differ from each other by 90 degrees.

As shown in FIG. 5A, when a sine wave signal wa is changed to a square wave signal wb, a level of the sine wave signal wa higher than a reference voltage VTH is set at a high level, and a level of the sine wave signal wa lower than the reference voltage VTH is set at a low level. To obtain a square waveform of a 50% duty ratio, it is required to set the threshold voltage VTH within a narrow range including the zero level of the sine wave signal wa. Further, when a level of a signal is rapidly changed, the signal electro-magnetically generates noises.

Assuming that the clock signals have the same phase, noise edges N generated by the voltage boosting clock signal are easily superposed on a sine wave signal used for the generation of the wave detecting clock signal at a time when the sine wave signal is placed at a level near to the zero level (or reference voltage VTH). When the noise edges N are superposed on the sine wave signal, a level of the sine wave signal slightly lower than the reference voltage VTH is undesirably heightened to a level higher than the reference voltage VTH, or a level of the sine wave signal slightly higher than the reference voltage VTH is undesirably lowered to a level lower than the reference voltage VTH. As a result, as shown in FIG. 5B, the sine wave signal used for the generation of the wave detecting clock signal is changed to a deformed sine wave signal wa′. When a wave detecting clock signal is generated from the deformed sine wave wa′, chattering or the like is caused during the generation of the wave detecting clock signal, and a wave detecting clock signal having a deformed square waveform wb′ is generated.

However, in this embodiment, the clock signals have the square waveforms of the 50% duty ratio of which the phases differ from each other by 90 degrees. In this case, noise edges N′ caused by the generation of the voltage boosting clock signal in the comparator 6k are superposed on the phase shifted vibration monitoring signal at a time when a level of the signal is sufficiently higher or lower than the reference voltage VTH. Therefore, as shown in FIG. 5C, even though the noise edges N′ are superposed on the phase shifted vibration monitoring signal wa, a level of the monitoring signal wa is not changed at a noise superimposing time so as to go across the reference voltage VTH. As a result, this angular rate sensor can effectively prevent from occurring chattering in the comparator 5 during the generation of the wave detecting clock signal, and the wave detecting clock signal wb not deformed can be generated.

Generally, when a non-sensitive zone is set in a square wave signal by a positive feedback or the like, chattering occurring in a comparator can be effectively prevented. However, the non-sensitive zone prevents the generation of a square wave signal set at a duty ratio of 50%. Therefore, the non-sensitive zone is not appropriate to the prevention of chattering. In this embodiment, the occurrence of chattering can be prevented without setting a non-sensitive zone in the wave detecting clock signal, and the wave detecting clock signal having a duty ratio of 50% can be easily and reliably obtained.

Accordingly, because the vibration monitoring signal obtained from the vibration of the vibrator 100 is used for the generation of both the wave detecting clock signal and the voltage boosting clock signal, size of the angular rate sensor can be reduced.

Further, because the voltage boosting clock signal is generated from the vibration monitoring signal, it is not required to dispose a circuit for generating the voltage boosting clock signal on the outside. Accordingly, the angular rate sensor can be simplified.

Moreover, because the vibrator 100 is driven by the driving signal derived from the vibration monitoring signal, the vibrator 100 mechanically vibrating is driven at a resonance frequency of the movable portion 30. Therefore, the vibrator 100 can reliably vibrate at the resonance frequency. Further, the driving signal is obtained by shifting the phase of the vibration monitoring signal by 90 degrees. Therefore, when the vibrator 100 is set in a condition that the displacement of the vibrator 100 is minimized (or vibration speed is maximized), the vibrator 100 is driven by a peak level of the driving signal. Accordingly, the vibrator 100 can be effectively driven, and the vibrator 100 can effectively maintain its vibration at the resonance frequency.

Further more, because the clock signals are generated so as to have the phases differing from each other by 90 degrees, the phase shifted vibration monitoring signal receives noises from the voltage boosting clock signal when being set at a highest or lowest level. Accordingly, the highest margin to noises can be obtained in the phase shifted vibration monitoring signal, and chattering occurring during the generation of the wave detecting clock signal can be most effectively prevented.

Still further, a change of a capacitance of a capacitor formed by the monitoring electrodes 60 is successively detected as an analog value to generate a driving signal of a sine waveform from a vibration monitoring signal. Therefore, the vibration detecting unit 71 can be simplified.

Still further, because the wave detecting clock signal has a square waveform of a duty ratio set at 50%, an angular velocity component can be detected from a vibration detecting signal in the PSD 22 at highest detection efficiency.

In this embodiment, the boosted voltage Vout of the voltage boosting circuit 4 is applied to the movable portion 30 as a bias voltage through a terminal K. In this case, a differential DC voltage is defined as a difference between the bias voltage and an offset voltage (that is, zero level) of the driving signal, and a driving force of the movable portion 30 is proportional to a product of the differential DC voltage and an amplitude (or AC voltage) of the driving signal. A gain of each C/V converter 2 is proportional to a differential voltage between the bias voltage and a reference voltage (normally, 2.5V) of the C/V converter 2. In the angular rate sensor, as the driving force of the movable portion 30 and the gain of the C/V converter 2 are increased, a signal-to-noise (SM) ratio of the voltage signal Vy becomes higher. To heighten the SN ratio, the voltage boosting circuit 4 is arranged in the sensor to heighten a voltage level of the driving signal and to apply the bias voltage to the movable portion 30. In this embodiment, the voltage boosting clock signal is supplied to the voltage boosting circuit 4.

Further, for the purpose of heightening the SN ratio, it is effective to heighten a gain of the C/V converter 120.

Moreover, in this embodiment, the vibration driving section 6 is configured as a self-vibration type to generate the driving signal from the vibration monitoring signal. However, this embodiment is not limited to the self-vibration type. A driving signal generated in a driver unit independently from the vibration monitoring signal may be transmitted to the vibrator 100. In this case, the boosted voltage Vout of the voltage boosting circuit 4 is applied to only the terminal K of the vibrator 100.

1. A vibration type angular rate sensor comprising:
a vibrator which vibrates along a reference direction at a fixed frequency in response to a driving signal, receives an angular velocity given to the vibrator, and vibrates along a detecting direction perpendicular to the reference direction in accordance with the angular velocity;
a monitoring signal generator which generates a monitoring signal having a waveform of the vibration of the vibrator along the reference direction;
a clock signal generator which generates, from the monitoring signal, a first clock signal and a second clock signal having a frequency identical with that of the first clock signal in a manner that a level of the first clock signal is changed at a time differing from that in the second clock signal, the first clock signal being used to maintain the vibration of the vibrator along the reference direction) and
an angular velocity detector which detects the angular velocity from a waveform of the vibration of the vibrator along the detecting direction by using the second clock signal and outputs the detected angular velocity as an angular rate given to the vibrator.

2. The sensor according to claim 1, wherein the clock signal generator includes a phase shifter which shifts a phase of the monitoring signal by a predetermined angle to obtain a phase shifted signal, one of the first clock signal and the second clock signal being generated from the monitoring signal, the other clock signal being generated from the phase shifted signal.

3. The Sensor according to claim 1, further comprising:
a voltage boosting unit which boosts an applied voltage by using the first clock signal generated in the clock signal generator to generate a signal of a boosted voltage,
a driving signal generator which generates the driving signal from the monitoring signal and boosts a voltage level of the driving signal by using the signal of the boosted voltage obtained in the voltage boosting unit.

4. The sensor according to claim 1, further comprising:
a voltage boosting unit which boosts an applied voltage by using the first clock signal generated in the clock signal generator to generate a signal of a boosted voltage,
wherein the vibrator has a fixed portion receiving the driving signal and a movable portion, and the movable portion is biased by the signal of the boosted voltage obtained in the voltage boosting unit and is moved in response to the driving signal received in the fixed portion.

5. The sensor according to claim 1, wherein the driving signal generator is configured as a self-vibration driver and comprises an amplitude detector which detects an amplitude of the monitoring signal, and a signal generator which compares the detected amplitude with a reference amplitude, sets the monitoring signal at a predetermined amplitude according to a comparison result to generate the driving signal from the monitoring signal, the driving signal being transmitted to a driving terminal of the vibrator to vibrate the vibrator along the reference direction.

6. The sensor according to claim 2, wherein the phase shifter generates the phase shifted signal of which the phase is shifted by 90 degrees from that of the monitoring signal, and phases of the clock signals differ from each other by 90 degrees.

7. The sensor according to claim 2, wherein the monitoring signal generated by the monitoring signal generator has a form of a sine wave, the phase shifter generates the phase shifted signal of which the phase is shifted by 90 degrees from that of the monitoring signal, each of the clock signals generated in the clock signal generator has a square wave set at a duty ratio of 50%, and the phases of the clock signals differ from each other by 90 degrees.

8. The sensor according to claim 1, wherein the monitoring signal has a sine waveform of the fixed frequency, the level of one of the clock signals is changed when the monitoring signal goes across its zero level, the level of the other clock signal is changed when the level of the monitoring signal is higher or lower than its zero level.

9. The sensor according to claim 6, further comprising:
a driving signal generator which generates the driving signal from the phase shifted signal generated from the monitoring signal to differentiate a phase of the driving signal from a phase of the first clock signal by 90 degrees.

10. The sensor according to claim 6, wherein the clock signal generator generates the second clock signal from the phase shifted signal.
